(19) United States
(12) Patent Application Publication
(10) Pub. No.: US 2026/0115654 A1
(43) Pub. Date: Apr. 30, 2026

(54) GAS-LIQUID SEPARATION APPARATUS

(71) Applicants: AISIN CORPORATION, Kariya-shi (JP); HONDA MOTOR CO., LTD., Tokyo (JP)

(72) Inventors: Koichi ARAKAWA, Kariya-shi (JP); Hitoshi OKUNO, Kariya-shi (JP)

(73) Assignees: AISIN CORPORATION, Kariya-shi (JP); HONDA MOTOR CO., LTD., Tokyo (JP)

(21) Appl. No.: 19/370,130

(22) Filed: Oct. 27, 2025

(30) Foreign Application Priority Data
Oct. 29, 2024 (JP) 2024-189580

(51) Int. Cl. B01D 53/26; H01M 8/04828

(52) U.S. Cl. CPC B01D 53/265; H01M 8/04835; B01D 2257/80; H01M 2250/20

(57) ABSTRACT

A gas-liquid separation apparatus includes: a housing; a gas inlet open in the housing and configured to allow a gas from a stack to be introduced; a gas-liquid separation section disposed in the housing and configured to separate water from the gas; a gas outlet open in the housing and configured to allow the separated gas from which the water has been separated to be drawn off; an exhaust port open in the housing separately from the gas outlet and configured to allow a portion of the separated gas to be discharged; an exhaust valve located downstream of the exhaust port in a flow direction of the separated gas; and a heating unit configured to heat the separated gas flowing from inside the housing to the exhaust port.

### CROSS REFERENCE TO RELATED APPLICATIONS

This application is based on and claims priority under 35 U.S.C. Section 119 to Japanese Patent Application No. 2024-189580 filed on October 29, 2024, the entire content of which is incorporated herein by reference.

### TECHNICAL FIELD

This disclosure relates to a gas-liquid separation apparatus.

### RELATED ART

Gas-liquid separators that separate a liquid contained in a gas are conventionally used. The technique described in JP 2023-67241A cited below is an example of a technique relating to this type of gas-liquid separator.

JP 2023-67241A describes a gas-liquid separator. This gas-liquid separator includes a gas-liquid separation section for separating water from a water-containing gas that is disposed at an upper portion of a housing to which the water-containing gas is supplied, and a water storage section for storing the water separated from the water-containing gas that is disposed at a lower portion of the housing. The water in the water storage section is discharged to the outside of the housing via an on-off valve. The water storage section is provided with a heating section for heating the water in the water storage section, at a bottom thereof. With this, even if water remaining at the bottom of the water storage section freezes, the outer surface of a heating case is heated by heat from the heating section, thereby making it possible to defrost the frozen portion in a short time.

### SUMMARY

Even if residual water freezes in a drain orifice passage for discharging the water in the water storage section, the gas-liquid separator described in JP 2023-67241A having the above configuration can properly defrost the frozen portion by heating it using the heating section disposed at a lower portion of the gas-liquid separator. However, some gas-liquid separators have an exhaust orifice passage for exhausting gas at an upper portion of the gas-liquid separator, whereas the gas-liquid separator described in JP 2023-67241A does not have the heating section at its upper portion. Thus, if water (water vapor) contained in the water-containing gas condenses in the exhaust orifice passage, this water may freeze and block the exhaust orifice passage. There is room for improvement in the gas-liquid separator described in JP 2023-67241A.

Embodiments of the present invention provides a gas-liquid separation apparatus capable of preventing blockage due to freezing.

A gas-liquid separation apparatus according to this disclosure includes: a housing; a gas inlet open in the housing and configured to allow a gas from a stack to be introduced; a gas-liquid separation section disposed in the housing and configured to separate water from the gas; a gas outlet open in the housing and configured to allow the separated gas from which the water has been separated to be drawn off; an exhaust port open in the housing separately from the gas outlet and configured to allow a portion of the separated gas to be discharged; an exhaust valve located downstream of the exhaust port in a flow direction of the separated gas; and a heating unit configured to heat the separated gas flowing from inside the housing to the exhaust port.

In this case, a separated gas from which water has been separated is heated by the heating unit. This can prevent freezing in the exhaust port and the exhaust valve through which the separated gas from the exhaust port flows. Accordingly, the gas-liquid separation apparatus can prevent freezing.

### BRIEF DESCRIPTION OF THE DRAWINGS

FIG. 1 is a perspective view of a gas-liquid separation apparatus.

FIG. 2 is a perspective view of a gas-liquid separation apparatus.

FIG. 3 shows a flow of a gas in the gas-liquid separation apparatus.

FIG. 4 is a cross-sectional view of a heating unit.

FIG. 5 shows a flow of a gas discharged from an exhaust valve.

FIG. 6 shows a heat transfer section according to another embodiment.

FIG. 7 shows a heat transfer section according to another embodiment.

FIG. 8 shows a heat transfer section according to another embodiment.

### DESCRIPTION OF EMBODIMENTS

A gas-liquid separation apparatus according to this disclosure is configured to prevent blockage due to freezing of a liquid separated from a gas. A description will be given of a gas-liquid separation apparatus 1 according to the present embodiment by taking an example in which the gas-liquid separation apparatus 1 separates water contained in an anode off-gas (an example of a “gas”) discharged from the anode side of fuel cells mounted in a fuel cell vehicle (FCV). However, the gas-liquid separation apparatus 1 is not limited to the following embodiment, and can be modified in various forms without departing from the gist of the embodiment.

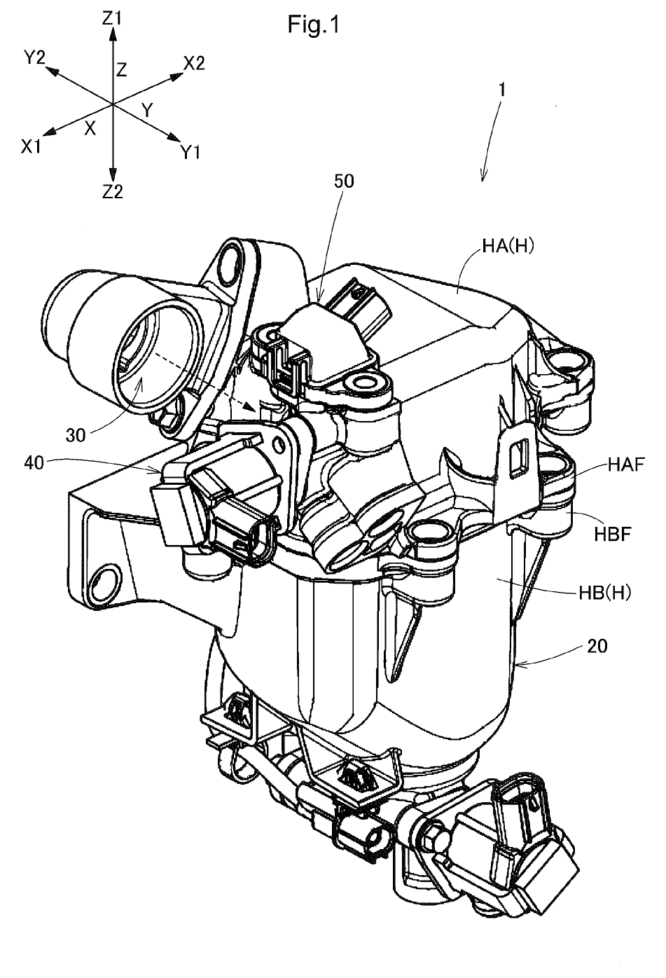

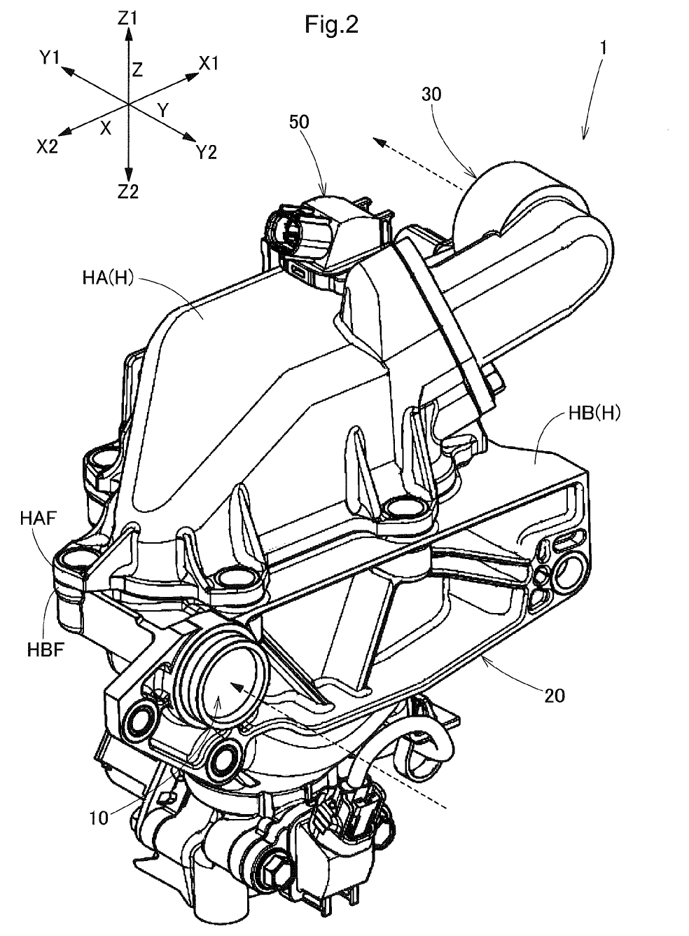

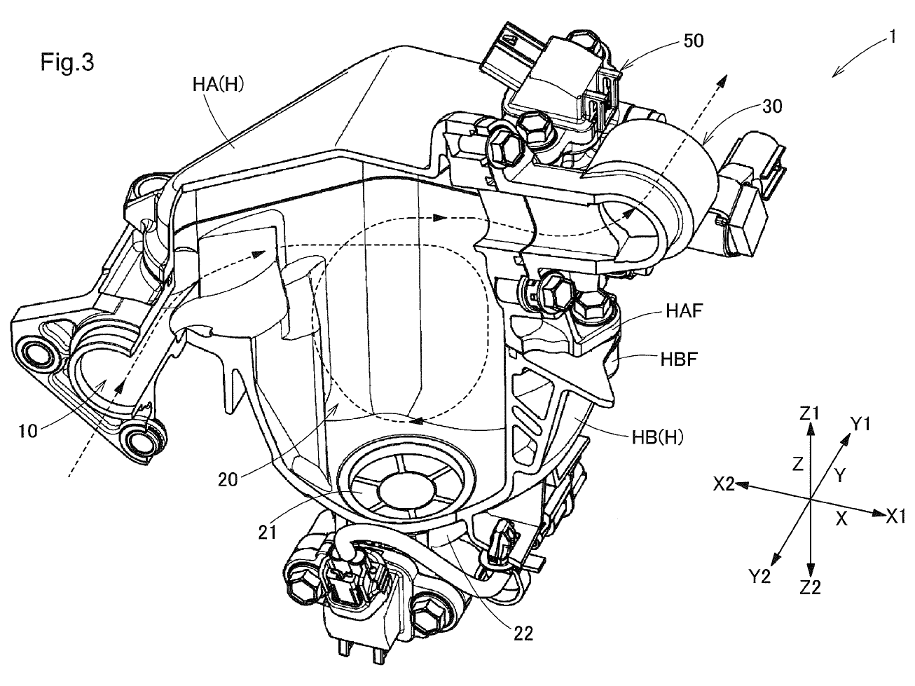

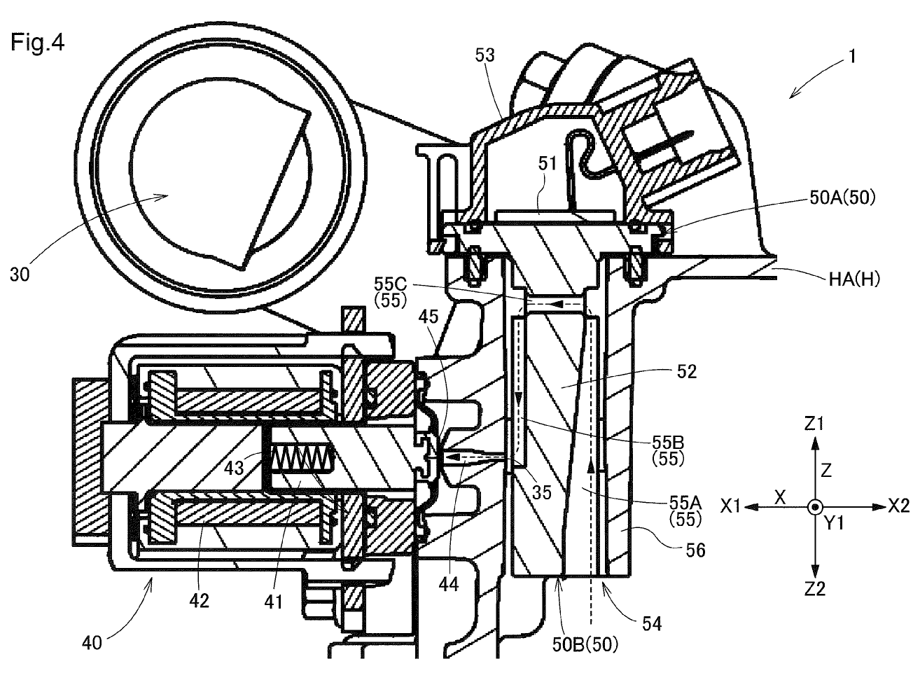

FIGS. 1 and 2 are perspective views of the gas-liquid separation apparatus 1. FIG. 3 shows how an anode off-gas introduced a housing H of the gas-liquid separation apparatus 1 flows (the flow of the anode off-gas is indicated by a dashed line). FIG. 4 is a cross-sectional view of an exhaust valve 40 and a heating unit 50 of the gas-liquid separation apparatus 1. In FIGS. 1 to 4, Z1 denotes the upper side in a vertical direction Z, and Z2 denotes the lower side in the vertical direction Z. X1 denotes one side in an X direction orthogonal to the vertical direction Z, and X2 denotes the other side in the X direction. Y1 denotes one side in a Y direction orthogonal to both the X and Z directions, and Y2 denotes the other side in the Y direction. Hereinafter, those sides may also be referred to as “X1 side”, “X2 side”, “Y1 side”, “Y2 side”, “Z1 side”, and “Z2 side”, respectively. FIG. 1 is a perspective view as viewed from between X1 and Y1, and FIG. 2 is a perspective view as viewed from the opposite side (from between X2 and Y2).

As shown in FIGS. 1 and 2, the gas-liquid separation apparatus 1 includes the housing H, a gas inlet 10, a gas-liquid separation section 20, a gas outlet 30, an exhaust port 35 (see FIG. 4), an exhaust valve 40, and a heating unit 50.

A fuel cell generates electricity by supplying a fuel gas containing a hydrogen gas to an anode gas flow path (not shown) and supplying an oxidizing gas (oxygen-containing air) to a cathode gas flow path (not shown). A fuel cell discharges an anode off-gas containing unreacted hydrogen gas and moisture from the anode side while generating electricity. The gas-liquid separation apparatus 1 separates the water contained in the anode off-gas and stores the separated water inside the housing H, and returns the anode off-gas from which the water has been separated (an example of a “separated gas”) to the anode side of the fuel cell, thereby making it possible to use unreacted hydrogen gas for power generation.

When the fuel cell stops generating electricity in a low-temperature environment to park a fuel cell vehicle, and thereafter starts to generate electricity, the water contained in the anode off-gas may freeze at a portion of the gas-liquid separation apparatus 1 through which the anode off-gas flows. If the water freezes, the frozen portion needs to be defrosted in a short time when the fuel cell starts generating electric power.

The gas-liquid separation apparatus 1 includes a heating section (not shown) on its lower side to prevent water stored inside (below) the housing H from freezing in a situation where the fuel cell vehicle travels in a low-temperature environment. In the present embodiment, the description of the heating section is omitted.

The housing H has an upper housing HA made of a resin, and a lower housing HB made of a resin. An upper flange HAF of the upper housing HA and a lower flange HBF of the lower housing HB are placed one on top of the other, and are fastened by a bolt (not shown).

The gas inlet 10 is located at a center of the housing H in the Z direction. The gas inlet 10 in the present embodiment is open on the Y2 side in the lower housing HB. An anode off-gas from a stack is introduced into the gas inlet 10. The “stack” refers to a fuel cell stack, which is an assembly of multiple cells. As mentioned above, the “anode off-gas” refers to a gas that contains water.

The gas-liquid separation section 20 is disposed in the housing H and separates water from the anode off-gas. The gas-liquid separation section 20 functions to bring the anode off-gas introduced from the gas inlet 10 into continuous contact with a plurality of collision walls provided inside the housing H, thereby separating water contained in the anode off-gas and causing the water to fall.

As shown in FIG. 3, the anode off-gas introduced from the gas inlet 10 is introduced into the gas-liquid separation section 20 in the housing H, and circulates in the housing H. During this circulation, the anode off-gas is separated into gas and water, and the gas is drawn off from the gas outlet 30, which will be described later. The separated water is passed through a foreign matter removal filter 21 located at a lower portion of the housing H and collected into a water collection section 22 located on the Z2 side with respect to the foreign matter removal filter 21.

The gas outlet 30 is provided in the upper housing HA and open on the Y1 side. The gas outlet 30 allows the separated gas from which the water has been separated to be drawn off. The “separated gas from which the water has been separated” refers to a gas from which water has been separated in the gas-liquid separation section 20. The gas outlet 30 is located on the Z1 side of the housing H. The separated gas drawn off from the gas outlet 30 is mixed with hydrogen from a hydrogen tank, and is again introduced to the stack.

As shown in FIG. 4, the exhaust port 35 is provided separately from the gas outlet 30 and open in the upper housing HA. The anode off-gas from which water has been separated in the gas-liquid separation section 20 in the housing H flows through the exhaust port 35. With this, the exhaust port 35 allows a portion of the anode off-gas to be discharged, separately from the gas outlet 30. As mentioned above, the separated gas obtained by separating water from the anode off-gas is drawn off from the gas outlet 30. The exhaust port 35 allows a portion of the separated gas to be discharged.

The exhaust valve 40 is located downstream of the exhaust port 35 in a flow direction of the separated gas. The exhaust valve 40 allows the separated gas from the exhaust port 35 to flow. As shown in FIG. 4, the exhaust valve 40 includes a plunger 41 made of a magnetic material, an electromagnetic solenoid 42 surrounding the plunger 41, a biasing member 43 that biases the plunger 41 in a protruding direction thereof, and a valve body 45 that is made of a flexibly deformable, membrane-like material, such as rubber, and is disposed at a position at which the valve body 45 blocks a downstream end of an orifice hole 44.

When the electromagnetic solenoid 42 is not energized, the exhaust valve 40 causes the plunger 41 to protrude due to a biasing force of the biasing member 43, as shown in FIG. 4. This protrusion causes the valve body 45 to block the orifice hole 44. Meanwhile, when the electromagnetic solenoid 42 is energized, the exhaust valve 40 moves the plunger 41 against the biasing force of the biasing member 43 to separate the valve body 45 from the orifice hole 44, thereby opening the orifice hole 44. The separated gas is discharged to the outside from the orifice hole 44 through the exhaust port 35. The exhaust valve 40 is thus configured to allow the separated gas to be discharged.

The heating unit 50 is located near the exhaust valve 40, and heats the separated gas flowing from inside the housing H to the exhaust port 35. The “separated gas flowing from inside the housing H to the exhaust port 35” refers to a separated gas from which water has been separated in the gas-liquid separation section 20, as mentioned above. Note that the separated gas contains water vapor.

The heating unit 50 includes a heating element 51 and a heat transfer section 52. The heating element 51 is provided in a base 50A of the heating unit 50. The base 50A side of the heating unit 50 is covered by a case 53, which accommodates the heating element 51. The heating element 51 emits Joule heat when energized. This heat is transferred to a heat transfer section 52, which will be described later.

The heat transfer section 52 is formed of metal (such as aluminum or copper). The heat transfer section 52 is located at a position facing the exhaust port 35. The heat transfer section 52 in this embodiment is in a state of being inserted into a resin case 56, which is provided in the housing H. The heat transfer section 52 transfers heat from the heating element 51. That is to say, the heat transfer section 52 transfers heat by heat conduction from the heating element 51 toward an end 50B on the side opposite to the heating element 51. As shown in FIG. 4, the heating element 51 has a surface on the Z2 side in contact with the heat transfer section 52. The heat transfer section 52 has a flow path 55 for the separated gas flowing to the exhaust port 35. While passing through the flow path 55, the separated gas is warmed by the heat from the heating element 51, and the warmed separated gas flows to the exhaust port 35.

The heat transfer section 52 extends from the base 50A toward the Z2 side. The heat transfer section 52 in the present embodiment extends farther than the exhaust port 35 (i.e., to a position separated from the exhaust port 35) as viewed from the base 50A along the Z direction. Accordingly, the base 50A, the exhaust port 35, and the end 50B are arranged in this order along the Z direction.

In the present embodiment, a portion of the separated gas is introduced from a side of the heat transfer section 52 opposite to the base 50A. In the present embodiment, the flow path 55 includes a first flow path 55A, a second flow path 55B, and a connecting path 55C. The heat transfer section 52 has an inlet 54 through which the separated gas flows in, on the end 50B side. The first flow path 55A is connected to the inlet 54. The first flow path 55A extends along the Z direction from the end 50B side toward the base 50A. Thus, the separated gas flowing in through the inlet 54 flows through the first flow path 55A toward the base 50A, and is warmed by the heat from the heat transfer section 52 while flowing through the flow path 55A.

The second flow path 55B extends along the Z direction from the base 50A side to a position facing the exhaust port 35 in the X direction. The connecting path 55C connects an end of the second flow path 55B on the Z1 side and an end of the first flow path 55A on the Z1 side. The connecting path 55C has an end on the X2 side connected to the end of the first flow path 55A on the Z1 side, and an end on the X1 side connected to the end of the second flow path 55B on the Z1 side. Thus, the flow path 55 allows a portion of the separated gas to turn back on the base 50A side and flow to the exhaust port 35. Accordingly, the separated gas receives the heat from the heat transfer section 52 and is warmed thereby while flowing from the first flow path 55A to the connecting path 55C and the second flow path 55B.

The exhaust port 35 is an opening of the orifice hole 44 on the upper housing HA side. In the present embodiment, a downstream end of the second flow path 55B is located at a position facing the exhaust port 35 in the X direction. With this, when the valve body 45 is open, the separated gas from the flow path 55 is discharged from the exhaust valve 40 through the orifice hole 44.

Here, the first flow path 55A is configured such that its flow path cross-sectional area orthogonal to the Z direction decreases from the end 50B toward the base 50A. In the present embodiment, the flow path cross-sectional area is uniform from the inlet 54 to a predetermined distance in the Z direction (a distance substantially corresponding to the length of the inlet 54 in the X direction), and then decreases toward the base 50A. Specifically, as shown in FIG. 4, the length of the first flow path 55A in the X direction decreases such that the inner wall of the first flow path 55A on the X1 side is tapered with respect to the Z direction, thereby reducing the flow path cross-sectional area. That is, the first flow path 55A has an opening on the upstream side larger than its opening on the downstream side. This reduces the flow resistance of the separated gas entering the heating unit 50, making it easy for the separated gas to flow in. Further, the separated gas flowing to the exhaust valve 40 can be warmed sufficiently.

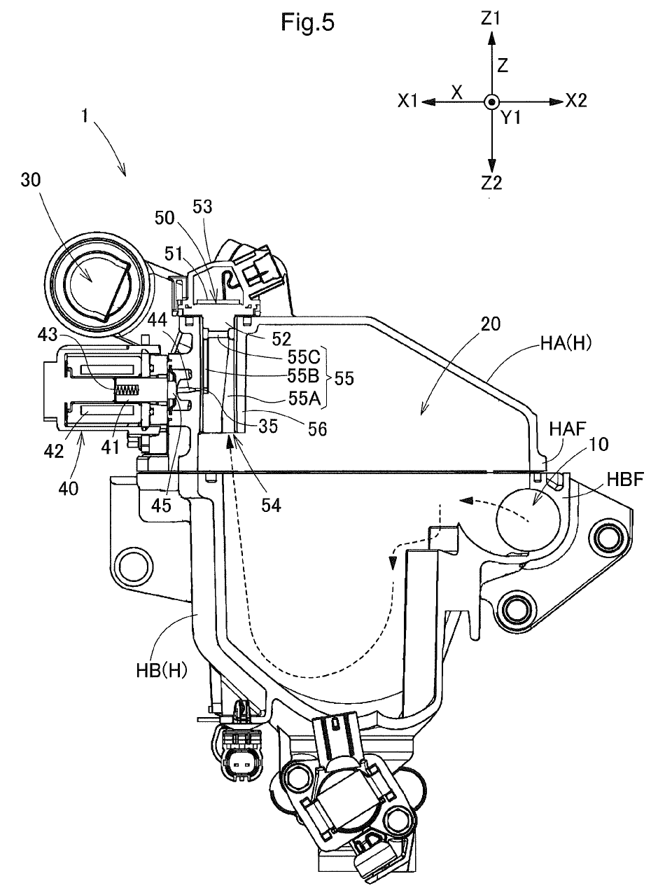

With the above configuration, the separated gas can be warmed in the heat transfer section 52 when discharged from the exhaust port 35 at the stage where water is separated from anode off-gas, as shown in FIG. 5. The water contained in these gases can thereby be prevented from freezing. Accordingly, the separated gas can be properly discharged from the exhaust port 35.

### Other Embodiments

Next, other embodiments of the gas-liquid separation apparatus 1 will be described.

In the above description, the heating unit 50 includes the heating element 51 and the heat transfer section 52. However, the heating unit 50 may include either one of the heating element 51 and the heat transfer section 52. In this case, the other one of the heating element 51 and the heat transfer section 52 can be provided in another unit different from the heating unit 50.

In the above embodiment, the heating element 51 is provided in the base 50A of the heating unit 50. However, if heat transfer to the heat transfer section 52 is possible, the heating element 51 can be provided at a location different from the base 50A of the heating unit 50.

In the above embodiment, the heat transfer section 52 extends from the base 50A in the Z direction (vertical direction). However, the heat transfer section 52 may alternatively extend laterally (in the X or Y direction) from the base 50A.

In the above embodiment, the flow path 55 is provided such that a portion of the separated gas is introduced from the side (the end 50B side) of the heat transfer section 52 opposite to the base 50A, turns back on the base 50A side, and flows to the exhaust port 35. However, the flow path 55 may also be configured such that a portion of the separated gas is introduced from the base 50A side of the heat transfer section 52, or may be configured such that the separated gas flows to the exhaust port 35 without turning back on the base 50A side.

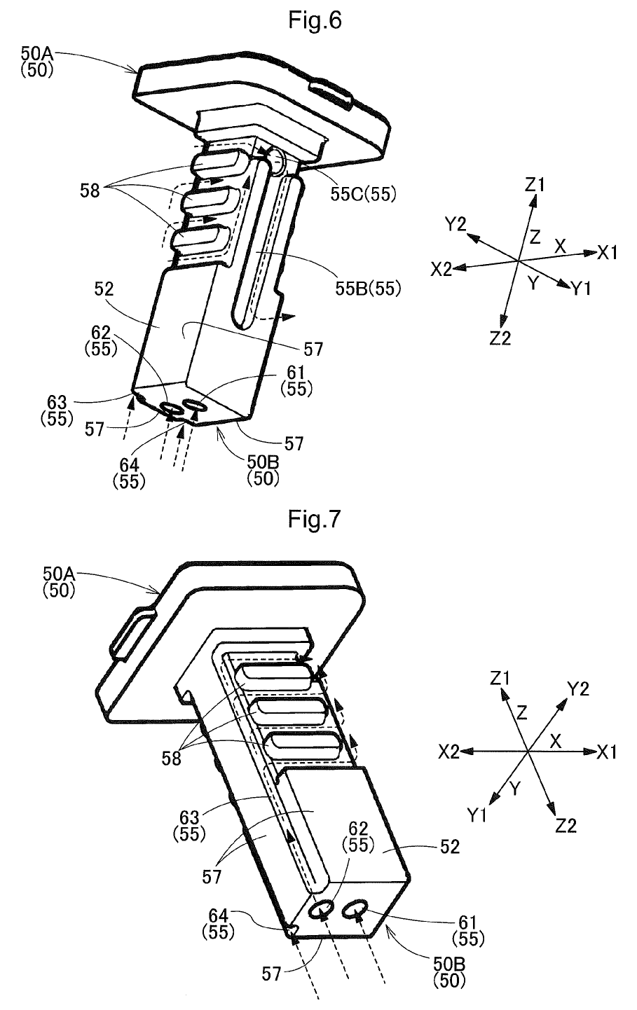

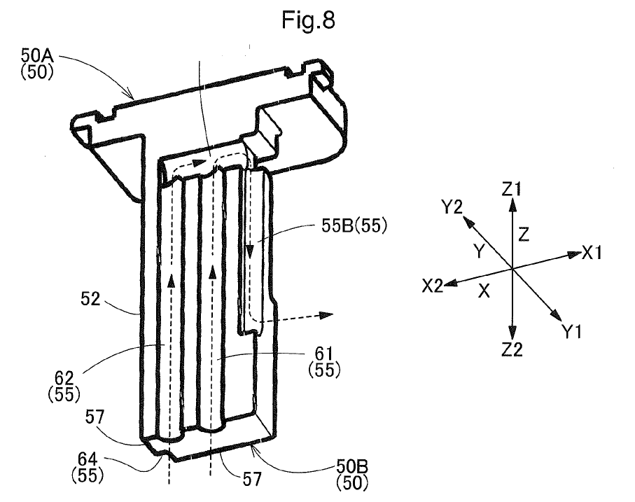

In the above embodiment, the heat transfer section 52 has the first flow path 55A (flow path 55) having a flow path cross-sectional area that gradually decreases along the Z direction from the end 50B side toward the base 50A. For example, as shown in FIGS. 6, 7, and 8, the heat transfer section 52 may have a plurality of (four in an example shown in FIGS. 6 to 8) flow paths 55 (i.e., a plurality of first flow paths 55A). Here, the four flow paths 55 (four first flow paths 55A) are respectively referred to as a flow path 61, a flow path 62, a flow path 63, and a flow path 64.

In the example shown in FIGS. 6 to 8, the flow paths 61 and 62 extend along the Z direction inside the heat transfer section 52. The flow paths 61 and 62 extend along the Z direction from the end 50B side toward the base 50A, and are connected to the connecting path 55C at the base 50A, as in the above embodiment. The second flow path 55B extends from the end of the connecting path 55C on the X2 side toward the Z2 side, up to the position facing the exhaust port 35 in the X direction.

In the example shown in FIGS. 6 to 8, the flow paths 63 and 64 are formed in an outer surface 57 of the heat transfer section 52. In the example shown in FIGS. 6 to 8, the flow paths 63 and 64 are formed at a corner of the heat transfer section 52 at which a YZ surface on the X2 side and an XZ surface on the Y1 side thereof intersect, and a corner of the heat transfer section 52 at which the YZ surface on the X2 side and an XZ surface on the Y2 side thereof intersect. The flow paths 63 and 64 are constituted by grooves formed in the outer surface 57. Thus, a portion of the separated gas flows along the outer surface 57 of the heat transfer section 52. Further, in the example shown in FIGS. 6 to 8, guides sections 58 for guiding a portion of the separated gas are formed on the outer surface 57 of the heat transfer section 52. Each guide section 58 is configured to increase the flow path length of the flow path 55, and is configured such that a portion of the separated gas flowing through the flow paths 63 and 64 flows along the X direction, and flows toward the Z1 side at the end on the X1 side. This configuration also allows the separated gas to be warmed by the heat from the heat transfer section 52 while the separated gas flows through the flow path 55.

### Summary of the Above Embodiment

The following is a summary of the above-described gas-liquid separation apparatus 1.

1. A gas-liquid separation apparatus 1 includes: a housing H; a gas inlet 10 open in the housing H and configured to allow a gas from a stack to be introduced; a gas-liquid separation section 20 disposed in the housing H and configured to separate water from the gas; a gas outlet 30 open in the housing H and configured to allow the separated gas from which the water has been separated to be drawn off; an exhaust port 35 open in the housing H separately from the gas outlet 30 and configured to allow a portion of the separated gas to be discharged; an exhaust valve 40 located downstream of the exhaust port 35 in a flow direction of the separated gas; and a heating unit 50 configured to heat the separated gas flowing from inside the housing H to the exhaust port 35.

In this case, the heating unit 50 heats a separated gas from which water has been separated, making it possible to prevent freezing in the exhaust port 35 and the exhaust valve 40 through which the separated gas from the exhaust port 35 flows. Accordingly, the gas-liquid separation apparatus 1 can prevent freezing.

2. In one embodiment of the gas-liquid separation apparatus 1 according to (1), the heating unit 50 includes: a heating element 51; and a heat transfer section 52 disposed at a position facing the exhaust port 35 and configured to transfer heat from the heating element 51, and the heat transfer section 52 has a flow path 55 for the separated gas flowing to the exhaust port 35.

In this case, the separated gas can be warmed while flowing through the flow path 55 provided in the heat transfer section 52. Therefore, it is possible to warm the separated gas efficiently while reducing the size of the heating element, compared to warming the separated gas using only the heating element 51.

3. In one embodiment of the gas-liquid separation apparatus 1 according to (2), the heating element 51 is in a base 50A of the heating unit 50, the heat transfer section 52 extends from the base 50A, and the flow path 55 is configured to allow a portion of the separated gas to be introduced from a side of the heat transfer section 52 opposite to the base 50A, turn back on the base 50A side, and flow to the exhaust port 35.

In this case, the length of the flow path 55 in the heat transfer section 52 can be increased. Therefore, the time for the separated gas to flow through the flow path 55 can be increased, and the separated gas can thereby be warmed sufficiently. Further, the separated gas sufficiently warmed in this manner flows through the exhaust valve 40, making it possible to prevent freezing at the exhaust valve 40.

4. In one embodiment of the gas-liquid separation apparatus 1 according to (2) or (3), the heat transfer section 52 has an outer surface 57 along which a portion of the separated gas flows, and the outer surface 57 of the heat transfer section 52 has a guide section 58 configured to guide a portion of the separated gas.

In this case, the time for the separated gas to flow through the heat transfer section 52 can be increased. Therefore, the separated gas can be properly heated by transferring heat from the heat transfer section 52 to the separated gas.

This disclosure can be applied to gas-liquid separation apparatuses.

What is claimed is:

1. A gas-liquid separation apparatus comprising:
a housing;
a gas inlet open in the housing and configured to allow a gas from a stack to be introduced;
a gas-liquid separation section disposed in the housing and configured to separate water from the gas;
a gas outlet open in the housing and configured to allow the separated gas from which the water has been separated to be drawn off;
an exhaust port open in the housing separately from the gas outlet and configured to allow a portion of the separated gas to be discharged;
an exhaust valve located downstream of the exhaust port in a flow direction of the separated gas; and
a heating unit configured to heat the separated gas flowing from inside the housing to the exhaust port.

2. The gas-liquid separation apparatus according to claim 1,
wherein the heating unit includes:
a heating element; and
a heat transfer section disposed at a position facing the exhaust port and configured to transfer heat from the heating element, and
the heat transfer section has a flow path for the separated gas flowing to the exhaust port.

3. The gas-liquid separation apparatus according to claim 2,
wherein the heating element is in a base of the heating unit,
the heat transfer section extends from the base, and
the flow path is configured to allow a portion of the separated gas to be introduced from a side of the heat transfer section opposite to the base, turn back on the base side, and flow to the exhaust port.

4. The gas-liquid separation apparatus according to claim 2,
wherein the heat transfer section has an outer surface along which a portion of the separated gas flows, and
the outer surface of the heat transfer section has a guide section configured to guide a portion of the separated gas.

5. The gas-liquid separation apparatus according to claim 3,
wherein the heat transfer section has an outer surface along which a portion of the separated gas flows, and
the outer surface of the heat transfer section has a guide section configured to guide a portion of the separated gas.
